(19) United States
(12) Patent Application Publication
(10) Pub. No.: US 2024/0141780 A1
(43) Pub. Date: May 2, 2024

(54) GENERATING DOWNHOLE FLUID COMPOSITIONS FOR WELLBORE OPERATIONS USING MACHINE LEARNING

(71) Applicant: Halliburton Energy Services, Inc., Houston, TX (US)

(72) Inventors: Feng Feng, Houston, TX (US); Fahad Ahmad, Cypress, TX (US); Tywon C. Veazie, Houston, TX (US); Jason Glen Bell, Houston, TX (US); Jay Deville, Spring, TX (US); Mohamed Abdelsalam, Sugar Land, TX (US)

(21) Appl. No.: 17/979,112

(22) Filed: Nov. 2, 2022

(51) Int. Cl. E21B 49/00; E21B 49/08

(52) U.S. Cl. CPC E21B 49/003; E21B 49/08; E21B 2200/22

(57) ABSTRACT

Some examples described herein relate to producing an optimized composition of a downhole drilling fluid. For example, a system can execute an iterative optimization process to determine an optimized composition of downhole drilling fluid that satisfies at least one objective function and matches a received set of target fluid properties. Each iteration of the iterative optimization process can involve: selecting a mixture of fluid components for the downhole drilling fluid from a search space, providing the selected mixture of fluid components as input to a trained machine-learning model, receiving a set of predicted fluid properties for the mixture of fluid components as output from the trained machine-learning model, and determining whether the set of predicted fluid properties matches the set of target fluid properties. The system can transmit a control signal to a mixing subsystem for causing the mixing subsystem to produce the optimized composition of the downhole drilling fluid.

### TECHNICAL FIELD

The present disclosure relates generally to wellbore drilling operations and, more particularly (although not necessarily exclusively), to using machine learning to generate downhole fluid compositions for wellbore drilling operations.

### BACKGROUND

Well systems for extracting hydrocarbons from a subterranean formation are typically formed by drilling a wellbore through the subterranean formation. Drilling fluids can be used during wellbore formation to stabilize the wellbore and control formation fluids. For instance, drilling fluids can be used to cool the drill bit, control pressure within the wellbore, and suspend and transport drill cuttings from the wellbore to the surface. After drilling, the wellbore can be completed and brought onto production. The ability to determine drilling fluid compositions at the rig-site remains a challenge despite decades of drilling wells. Drilling fluids are generally complex compositions that can change during active drilling.

### BRIEF DESCRIPTION OF THE DRAWINGS

FIG. 1 is a cross-sectional view of an example of a well system according to some aspects of the present disclosure.

FIG. 2 is a block diagram of an example of a computing device for determining an optimized composition of a downhole drilling fluid using machine learning according to some aspects of the present disclosure.

FIG. 3 is a flowchart of an example of a process for determining an optimized composition of a downhole drilling fluid using machine learning according to some aspects of the present disclosure.

FIG. 4 is a diagram of an example of an iterative optimization process for determining an optimized composition of a downhole drilling fluid according to some aspects of the present disclosure.

### DETAILED DESCRIPTION

Certain aspects and examples of the present disclosure relate to generating downhole drilling fluid compositions for wellbore operations using machine learning in an iterative optimization process. Different wellbore operations may require downhole drilling fluids with different fluid properties, which are dependent on the composition of the downhole drilling fluid. To determine an optimized composition of the downhole drilling fluid, the iterative optimization process can involve constructing an objective function to optimize for certain variables, such as drilling speed. The iterative optimization process can be an optimization algorithm that can use a trained machine-learning model with the objective function to generate compositions for the downhole drilling fluid. The compositions can have fluid properties predicted by the trained machine-learning model that are similar to target fluid properties. The optimization algorithm can iterate and adjust the components in the fluid composition until the predicted fluid properties match the target fluid properties. The final set of fluid components can be the optimized composition of the downhole drilling fluid. Additionally, the optimized composition can be automatically produced at the wellbore to be used in wellbore operations.

Using an appropriate drilling fluid type can be critical for wellbore operations. Due to the variability of formation properties, there is a great variability of drilling fluid compositions needed for different wellbore operation parameters. Conventional methods for designing a composition for a downhole drilling fluid can require substantial experience from human chemists that may select from hundreds of materials with different fluid properties. Additionally, fluid compositions may involve multiple interrelated constraints that must be fulfilled concurrently, further complicating the composition selection. Moreover, some fluid properties of potential compositions cannot be determined without costly or time-consuming lab experiments. As a result, it can be challenging to find an optimum material composition that fulfills wellbore operation parameters and can be determined relatively quickly without significant lab experimentation.

Some examples of the present disclosure can overcome one or more of the abovementioned problems by using machine learning in an iterative optimization process to quickly identify optimized compositions that are optimized for certain variables, such as cost or drilling speed. A user can provide target fluid properties for the optimized composition, as well as other constraints such as available fluid components or quantities for the optimized composition. The iterative optimization process can be implemented using an optimization algorithm, such as a Bayesian optimization algorithm, a genetic algorithm, or a Latin hypercube algorithm. Based on the inputted constraints from the user, as well as an objective function for optimizing variables such as drilling speed, the iterative optimization process can use a trained machine-learning model to generate the optimized composition. For example, a first iteration of the iterative optimization process can involve providing fluid components that satisfy the objective function as input into the trained machine-learning model. The trained machine-learning model can then output predicted fluid properties for the fluid components, which may or may not match the target fluid properties from the user. If the predicted fluid properties do not match the target fluid properties, the iterative optimization process can perform further iterations. Each further iteration can use adjusted fluid components inputted into the trained machine-learning model until an outputted set of predicted fluid properties matches the target fluid properties from the user. The final set of fluid components can be the optimized composition, which can be automatically produced for use in wellbore operations. In some examples, the iterative optimization process may determine multiple sets of fluid components with predicted fluid properties that match the target fluid properties. In such examples, the set of fluid components that most closely satisfies the objective function can be the optimized composition.

The trained machine-learning model can be an algorithm that is trained using training data to make predictions or decisions. The trained machine-learning model may detect patterns within training data and these patterns may be used to make predictions or decisions in relation to new data. The trained machine-learning model can be trained with historical data relating fluid components to fluid properties. This can allow the trained machine-learning model to output predicted fluid properties based on inputted fluid components and their quantities, along with other treatments such as aging processes. The trained machine-learning model can therefore simulate a lab experiment that would normally require fluid preparation, aging, measurement, and hours or days to complete. Instead, the trained machine-learning model can determine a prediction within seconds.

Downhole drilling fluid can be a complex mixture, with hundreds of potential fluid components that may be used. To simplify the modeling process and to improve model accuracy and robustness, the historical data used to train a machine-learning model to generate the trained machine-learning model can be simplified. For example, certain fluid components in the historical data can be grouped according to their similarities into a single fluid component group. Such fluid component groups can include fluid components with similar characteristics, such as similar plastic viscosity, yield point, pH, API fluid loss, or any combination of these. Grouping the fluid components can allow the trained machine-learning model to remain useful even after newer, but similar ingredients are introduced. In some examples, separate models can be trained for different fluid types and fluid sub-types to maximize model accuracy and ease of training.

In some examples, the predicted fluid properties outputted by the trained machine-learning model for inputted fluid components may differ somewhat to actual fluid properties measured in lab experiments. It may be beneficial to incorporate one or more rounds of lab experiment data in the historical data used to train the machine-learning model. This can increase the robustness and accuracy of the optimized composition determined in the iterative optimization process. For example, after one or more iterations in the iterative optimization process, the most recent mixture of fluid components inputted into the trained machine-learning model can be tested in a lab experiment. The historical data used to train the trained machine-learning model can be modified to include the resulting measured fluid properties from the lab experiment. Then, the trained machine-learning model can be further trained with the modified historical data. Training with the modified historical data can correct some of the inaccuracies previously outputted by the trained machine-learning model.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

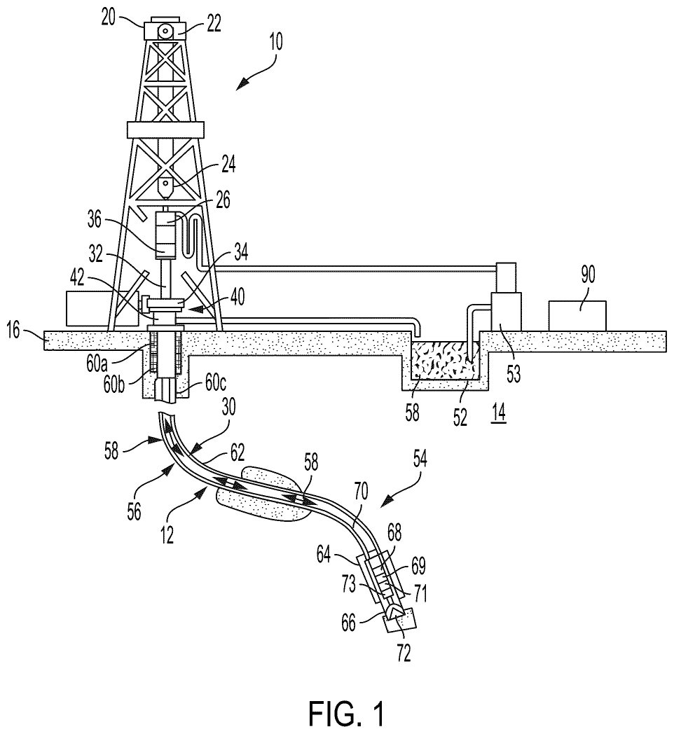

FIG. 1 is a cross-sectional view of an example of a well system 10 according to some aspects of the present disclosure. The well system 10 can include a wellbore 12 extending through various earth strata in an oil and gas formation 14 (e.g., a subterranean formation) located below the well surface 16. The wellbore 12 may be formed of a single bore or multiple bores extending into the formation 14, and disposed in any orientation. The well system 10 can include a derrick or drilling rig 20. The drilling rig 20 may include a hoisting apparatus 22, a travel block 24, and a swivel 26 for raising and lowering casing, drill pipe, coiled tubing, and other types of pipe or tubing strings or other types of conveyance vehicles, such as wireline, slickline, and the like. The wellbore 12 can include a drill string 30 that is a substantially tubular, axially-extending drill string formed of a drill pipe joints coupled together end-to-end.

The drilling rig 20 may include a kelly 32, a rotary table 34, and other equipment associated with rotation or translation of drill string 30 within the wellbore 12. For some applications, the drilling rig 20 may also include a top drive unit 36. The drilling rig 20 may be located proximate to a wellhead 40, as shown in FIG. 1, or spaced apart from the wellhead 40, such as in the case of an offshore arrangement. One or more pressure control devices 42, such as blowout preventers (BOPs) and other well equipment may also be provided at wellhead 40 or elsewhere in the well system 10. Although the well system 10 of FIG. 1 is illustrated as being a land-based drilling system, the well system 10 may be deployed offshore.

A drilling or service fluid source 52 may supply a downhole drilling fluid 58 pumped to the upper end of the drill string 30 and flowed through the drill string 30. The fluid source 52 may supply any fluid utilized in wellbore operations, including drilling fluid, drill-in fluid, acidizing fluid, liquid water, steam, or some other type of fluid.

The well system 10 may have a pipe system 56. For purposes of this disclosure, the pipe system 56 may include casing, risers, tubing, drill strings, subs, heads or any other pipes, tubes or equipment that attaches to the foregoing, such as the drill string 30, as well as the wellbore and laterals in which the pipes, casing, and strings may be deployed. In this regard, the pipe system 56 may include one or more casing strings 60 cemented in the wellbore 12, such as the surface 60a, intermediate 60b, and other casing strings 60c shown in FIG. 1. An annulus 62 is formed between the walls of sets of adjacent tubular components, such as concentric and non-concentric casing strings 60 or the exterior of drill string 30 and the inside wall of the wellbore 12 or the casing string 60c.

Where the subsurface equipment 54 is used for drilling and the conveyance vehicle is a drill string 30, the lower end of the drill string 30 may include a bottom hole assembly 64, which may carry at a distal end a drill bit 66. During drilling operations, a weight-on-bit is applied as the drill bit 66 is rotated, thereby enabling the drill bit 66 to engage the formation 14 and drill the wellbore 12 along a predetermined path toward a target zone. In general, the drill bit 66 may be rotated with the drill string 30 from the drilling rig 20 with the top drive unit 36 or the rotary table 34, or with a downhole motor 68 (e.g., a mud motor) within the bottom hole assembly 64.

The bottom hole assembly 64 or the drill string 30 may include various other tools, including a power source 69, a rotary steerable system 71, and measurement equipment 73. The measurement equipment 73 can include sensors configured to detect characteristics of the drill string 30, the wellbore 12, or the formation 14. Examples of the sensors can include temperature sensors, pressure sensors, fluid-flow sensors, fluid-type sensors, accelerometers, strain gauges, gyroscopes, cameras, microphones, or any combination of these. The sensors can transmit sensor data to a computing device 90 for use in determining or adjusting composition of the downhole drilling fluid 58.

Sensor data and other information from the measurement equipment 73 may be communicated using electrical signals, acoustic signals, or other telemetry that can be received at the well surface 16 to, among other things, monitor the performance of the drill string 30, the bottom hole assembly 64, and the associated drill bit 66. Sensor data may also be communicated to monitor the conditions of the environment to which the bottom hole assembly 64 is subjected, such as a flow rate of the downhole drilling fluid 58.

The downhole drilling fluid 58 may be pumped to the upper end of drill string 30 and flow through a longitudinal interior 70 of the drill string 30, through the bottom hole assembly 64, and exit from nozzles formed in the drill bit 66. At the bottom end 72 of the wellbore 12, the downhole drilling fluid 58 may mix with formation cuttings, formation fluids and other downhole fluids and debris. The drilling fluid mixture may then flow upwardly through an annulus 62 to return formation cuttings and other downhole debris to the well surface 16. While drilling through the formation 14, the measurement equipment 73 can provide (e.g., in real time) sensor data to the computing device 90. The computing device 90 can analyze the sensor data from the measurement equipment 73 to determine fluid properties of the downhole drilling fluid 58.

In some examples, the computing device 90 can form part of an automated control system. In some such examples, the computing device 90 can execute an iterative optimization process to use machine learning to determine an optimized composition of downhole drilling fluid 58. The computing device 90 can generate and transmit one or more control signals based on the optimized composition to one or more components of the well system 10. The control signals can cause the components, such as a mixing subsystem 53 in the fluid source 52, to produce the optimized composition of the downhole drilling fluid 58. Such downhole drilling fluid 58 with the optimized composition can then be used in wellbore operations downhole.

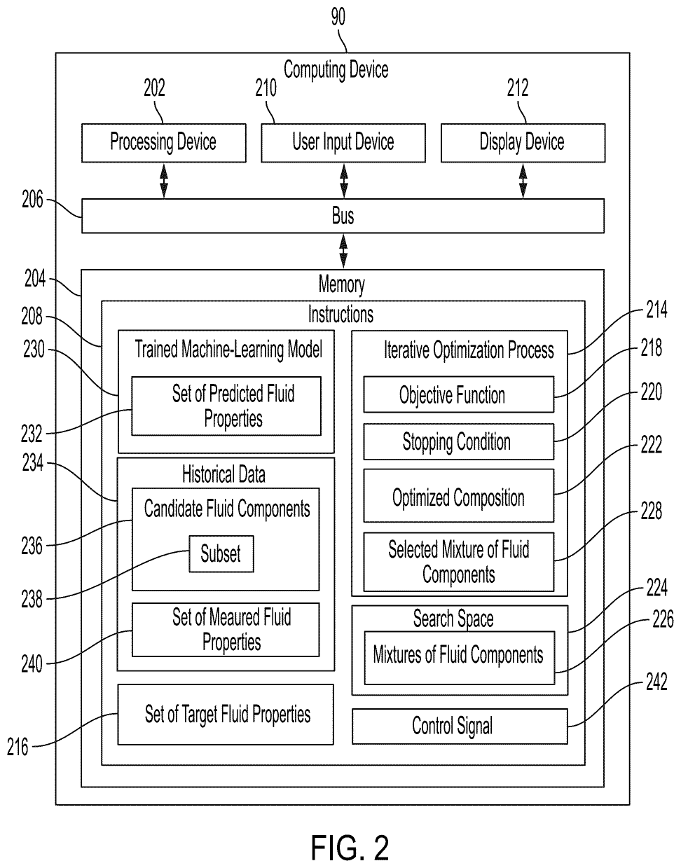

FIG. 2 is a block diagram of an example of a computing device 90 for determining an optimized composition 222 of a downhole drilling fluid 58 using machine learning according to some aspects of the present disclosure. The computing device 90 includes a processing device 202 communicatively coupled to a user input device 210, a display device 212, and a memory 204 by a bus 206. Although these components are shown in FIG. 2 as being internal to a housing of the computing device 90, it will be appreciated that in other examples these components can be distributed and remote from one another.

The processing device 202 can include one processor or multiple processors. Non-limiting examples of the processing device 202 include a Field-Programmable Gate Array (FPGA), an application-specific integrated circuit (ASIC), or a microprocessor. The processing device 202 can execute instructions 208 stored in the memory 204 to perform operations. In some examples, the instructions 208 can include processor-specific instructions generated by a compiler or an interpreter from code written in any suitable computer-programming language, such as C, C++, C#, etc.

The user input device 210 can include one user input device or multiple user input devices. Examples of such user input devices can include a keyboard, mouse, or touch-screen display. The display device 212 can include one display device or multiple display devices. Examples of such display devices can include a liquid crystal display (LCD) and a light-emitting diode (LED) display.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory can include a non-transitory computer-readable medium from which the processing device 202 can read instructions 208. A computer-readable medium can include electronic, optical, magnetic, or other storage devices capable of providing the processing device 202 with computer-readable instructions or other program code. Examples of the non-transitory computer-readable medium include magnetic disk(s), memory chip(s), ROM, random-access memory (RAM), an ASIC, a configured processor, optical storage, or any other medium from which a computer processor can read the instructions 208.

The instructions 208 can be executed by the processing device 202 to generate an optimized composition 222 of downhole drilling fluid 58 using an iterative optimization process 214. For example, the processing device 202 can receive a set of target fluid properties 216 as input from a user, such as through the user input device 210. The processing device 202 can execute the iterative optimization process 214, which can determine the optimized composition 222 that satisfies at least one objective function 218 and matches the set of target fluid properties 216. The iterative optimization process 214 can iterate until a stopping condition 220 is satisfied. For example, each iteration of the iterative optimization process 214 can involve the processing device 202 calling a trained machine-learning model 230. The trained machine-learning model 230 can be generated by training a machine-learning model with historical data 234. The historical data 234 can include candidate fluid components 236 and their associated fluid properties, which may be determined based on existing lab results. Thus, the trained machine-learning model 230 can be used to output predicted fluid properties in response to receiving inputting fluid components.

For each iteration, the iterative optimization process 214 can involve the processing device 202 selecting a mixture of fluid components 228 from a search space 224 that includes multiple mixtures of fluid components 228. The selected mixture of fluid components 228 can be provided as input to the trained machine-learning model 230, which can output a set of predicted fluid properties 232. The processing device 202 can then determine if a stopping condition 220 is satisfied. If the stopping condition 220 is not satisfied, the iterative optimization process 214 can continue with a further iteration involving an adjustment to inputs to the trained machine-learning model 230 to receive outputs that are closer to the set of target fluid properties 216. Iterations can continue until the stopping condition 220 is satisfied, at which point the final selected mixture of fluid components 228 can be the optimized composition 222. The processing device 202 can then output a control signal 242 causing a mixing subsystem 53 to produce the optimized composition 222 of the downhole drilling fluid 58.

The objective function 218 can be constructed based on constraints received from the user. Examples of the constraints can include the set of target fluid properties 216 and a variable to be optimized, such as minimized cost or maximized drilling speed. The objective function 218 can then be used with the trained machine-learning model 230 in iterations of the iterative optimization process 214. For example, the iterative optimization process 214 can be represented mathematically below in the following equations, where density is den, API is api, plastic viscosity is pv, pH is ph, yield point is yp, and the machine-learning model 230 is f(x):

$$min drilling speed ( x , c )$$

$$subject to$$

$${x}_{i} \leq 1 , i = 1 , … , n$$

$${x}_{i} \geq 0 , i = 1 , … , n$$

$${\sum }_{i = 1}^{n} {x}_{i} = 1$$

$$lower {bound}_{den} \leq {f}_{den} ( x ) \leq upper {bound}_{den}$$

$$lower {bound}_{api} \leq {f}_{api} ( x ) \leq upper {bound}_{api}$$

$$lower {bound}_{pv} \leq {f}_{pv} ( x ) \leq upper {bound}_{pv}$$

$$lower {bound}_{ph} \leq {f}_{ph} ( x ) \leq upper {bound}_{ph}$$

$$lower {bound}_{yp} \leq {f}_{yp} ( x ) \leq upper {bound}_{yp}$$

The iterative optimization process 214 can be implemented with the above equations using an optimization algorithm, such as a Bayesian optimization algorithm, a genetic algorithm, or a Latin hypercube algorithm. The optimization algorithm can determine a global optimization without requirements on the continuity of the objective function 218 or the constraint functions. In some examples, the global optimization may not converge, but can still provide meaningful near-optimal solutions. Additionally, multiple machine-learning models can run in parallel to one another as part of the iterative optimization process 214.

In some examples, the trained machine-learning model 230 can be improved by modifying the historical data 234 used to train the trained machine-learning model 230. For example, the historical data 234 may include a relatively large number (e.g., hundreds or thousands) of candidate fluid components 236. Such a large number may increase difficulty for the trained machine-learning model 230 in determining fluid properties as outputs. To simplify the historical data 234 and improve functioning of the trained machine-learning model 230, the historical data 234 can be modified to combine similar candidate fluid components 236. For example, the processing device 202 can identify a subset 238 of fluid components from among the candidate fluid components 236 that perform a same function in the downhole drilling fluid 58. In one example, the processing device 202 may identify a subset 238 of candidate fluid components 236 that act as viscosifiers in downhole drilling fluid 58. The processing device 202 can then modify the historical data 234 to replace the subset 238 of fluid components with a single fluid component (such as a single viscosifier) that is representative of the subset 238 of fluid components. The machine-learning model can be trained with the modified historical data 234 to generate the trained machine-learning model 230.

Additionally, the trained machine-learning model 230 can be updated using lab data. For example, after at least one iteration of the iterative optimization process 214 produces a set of predicted fluid properties 232 for a selected mixture of fluid components 228, the selected mixture of fluid components 228 can be tested in a lab experiment. The lab experiment can produce a set of measured fluid properties 240 for the selected mixture of fluid components 228. The user can input the set of measured fluid properties 240 for the selected mixture of fluid components 228 via the user input device 210. The processing device 202 can then modify the historical data 234 used to train the trained machine-learning model 230 to include the set of measured fluid properties 240. In some examples, the set of measured fluid properties 240 can be duplicated one or more times within the historical data 234 to increase a weight within the historical data 234. This is because the candidate fluid components 236 may be less accurate but can be easily generated in large volume, while the set of measured fluid properties 240 are more accurate with less volume. So, increasing the volume of the set of measured fluid properties 240 in the historical data 234 can increase the accuracy of the trained machine-learning model 230. After the historical data 234 is updated to include the set of measured fluid properties 240, the trained machine-learning model 230 can be further trained using the modified historical data 234.

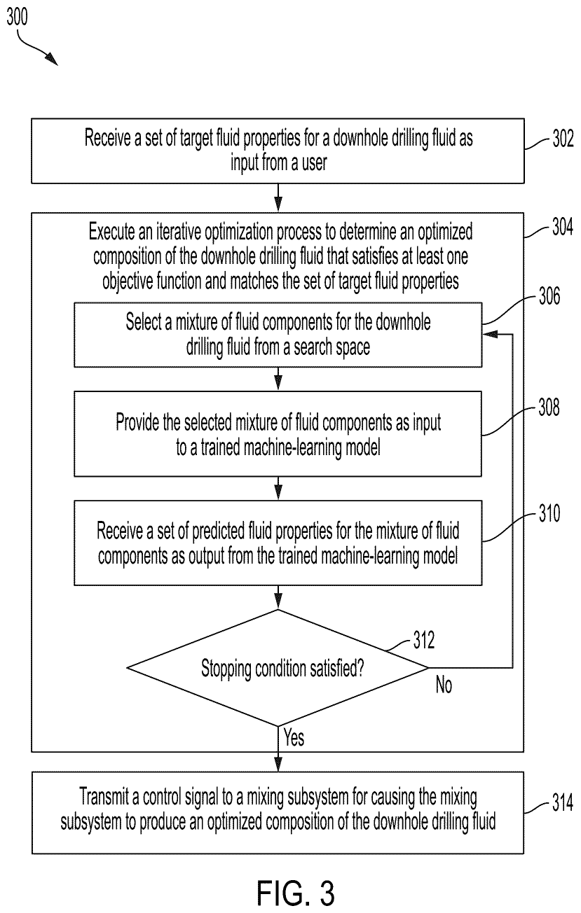

In some examples, the processing device 202 can implement some or all of the steps shown in FIG. 3. Other examples may involve more steps, fewer steps, different steps, or a different order of the steps than is shown in FIG. 3. The steps of FIG. 3 are described below with reference to components described above in regard to FIGS. 1-2.

Turning to FIG. 3, the process 300 begins at block 302 with receiving, by the processing device 202, a set of target fluid properties 216 for a downhole drilling fluid 58 as input from a user. For example, the set of target fluid properties 216 can involve values for density, viscosity, yield point, or pH of the downhole drilling fluid 58. In some examples, the processing device 202 can receive further constraints from the user. For example, a particular well site may have limited access to certain fluid components that may be used in the downhole drilling fluid 58. The user can therefore input restrictions to types or amounts of certain fluid components to the processing device 202. The processing device 202 can also receive a variable to be optimized in the composition. For example, the user may input drilling speed for the drill bit 66 as a variable to be maximized when determining the selected mixture of fluid components 228.

At block 304, the process 300 involves executing, by the processing device 202, an iterative optimization process 214 to determine an optimized composition 222 of the downhole drilling fluid 58. The optimized composition 222 may satisfy at least one objective function 218 and match the set of target fluid properties 216. The objective function 218 can be optimized for the variable input by the user, such as the drilling speed downhole. The iterative optimization process 214 can involve one or more iterations to determine the optimized composition 222, where each subsequent iteration is informed by results from the previous iteration. The iterations can continue until a stopping condition 220 is satisfied. In one example, the stopping condition 220 can be satisfied when a set of predicted fluid properties 232, determined for a selected mixture of fluid components 228 during the iterative optimization process 214, matches the set of target fluid properties 216 input by the user. Additionally, if multiple sets of predicted fluid properties are generated that match the set of target fluid properties 216, the processing device 202 can determine a set of predicted fluid properties 232 that most closely fulfills the objective function 218. Blocks 306, 308, 310, and 312 involve a current iteration of the iterative optimization process 214.

At block 306, the iterative optimization process 214 involves selecting, by the processing device 202, a mixture of fluid components for the downhole drilling fluid 58 from a search space 224. The search space 224 can include all potential mixtures of fluid components 226 for the downhole drilling fluid 58. In some examples, the search space 224 may be restricted to exclude certain fluid components, such as based on constraints input by the user. For example, certain fluid components may be unavailable or impractical for use at a particular drilling site. The processing device 202 can determine the selected mixture of fluid components 228 based on input from the user, by random selection, or based on previously determined compositions for downhole drilling fluids with a similar set of target fluid properties 216. Additionally or alternatively, the selected mixture of fluid components 228 can be determined to optimize the objective function 218. The selected mixture of fluid components 228 can include the fluid components, the quantities of each fluid component, and any treatment steps involved in generating downhole drilling fluid using the selected mixture of fluid components 228.

At block 308, the iterative optimization process 214 involves providing, by the processing device 202, the selected mixture of fluid components 228 as input to a trained machine-learning model 230. Based on training with historical data 234 indicating fluid properties of candidate fluid components 236, the trained machine-learning model 230 can generate a set of predicted fluid properties 232 for the selected mixture of fluid components 228. The trained machine-learning model 230 can then output the set of predicted fluid properties 232 for the selected mixture of fluid components 228.

In some examples, the iterative optimization process 214 can execute on a first computer (e.g., computing device 90) and the trained machine-learning model 230 can execute on a second computer, where the second computer is in networked communication with the first computer. So, the first computer can transmit the selected mixture of fluid components 228 to the second computer via one or more networks. The second computer can then receive the selected mixture of fluid components 228 and provide it as input to the trained machine-learning model 230.

At block 310, the iterative optimization process 214 involves receiving, by the processing device 202, the set of predicted fluid properties 232 for the selected mixture of fluid components 228 as output from the trained machine-learning model 230. For example, if the iterative optimization process 214 is executing on a first computer (e.g., computing device 90) and the trained machine-learning model 230 is executing on a second computer, the second computer can transmit the set of predicted fluid properties 232 to the first computer via one or more networks. The first computer can then receive the set of predicted fluid properties 232 and use it in the iterative optimization process 214.

At block 312, the iterative optimization process 214 involves determining, by the processing device 202, whether the stopping condition 220 for the iterative optimization process 214 is satisfied. For example, the processing device 202 can determine that the stopping condition 220 has not been satisfied if the set of predicted fluid properties 240 does not match the set of target fluid properties 216. If the stopping condition 220 has not been satisfied, the process 300 continues to block 306 to perform a subsequent iteration of the iterative optimization process 214. The selected mixture of fluid components 228 determined in the subsequent iteration of the iterative optimization process 214 can be informed by the results of the previous iteration. For example, the processing device 202 can determine a difference between the set of predicted fluid properties 232 and the set of target fluid properties 216. The selected mixture of fluid components 228 can be informed by the difference. In one example, the difference can be a difference in density. Therefore, the processing device 202 can adjust the selected mixture of fluid components 228 to include denser fluid components. The processing device 202 can determine that the stopping condition 220 is satisfied, for example if a predefined number of iterations has occurred or if an optimal fluid composition (e.g., mixture) has been identified. If the stopping condition 220 is satisfied, the iterative optimization process 214 is complete and the process 300 continues to block 314.

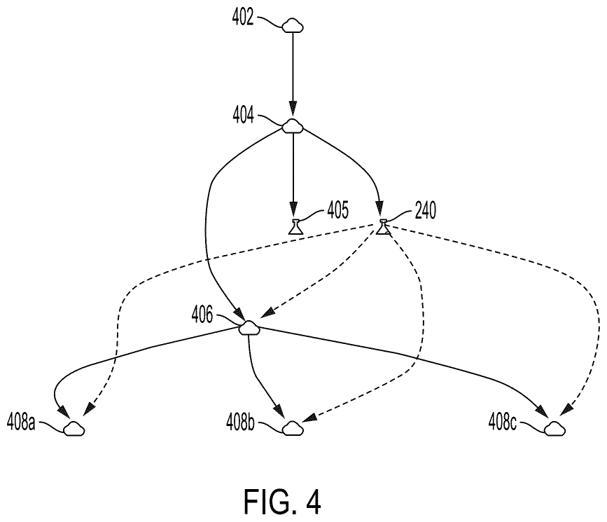

In some examples, after performing the iterative optimization process 214, further iterative optimization processes can be performed using the optimized composition determined during the first iterative optimization process 214. This is depicted in FIG. 4, which is a diagram of an example of multiple rounds of an iterative optimization process 214 for determining an optimized composition 222 of a downhole drilling fluid 58 according to some aspects of the present disclosure. The components and steps of FIG. 4 below are described with respect to components and steps described in regard to FIGS. 1-3.

The iterative optimization process 214 can be performed as described above with respect to FIG. 3 in a first round 402, producing a first optimized composition. In some examples, further rounds of the iterative optimization process 214 can be performed using the first optimized composition. For example, a user may input an adjustment to the objective function 218 or the first optimized composition and start a second round 404 of the iterative optimization process 214. The second round 404 may use the first optimized composition determined in the first round 402 as the selected mixture of fluid components 228 inputted into the trained machine-learning model 230. The second round 404 may produce results 405 (e.g., a second optimized composition).

To improve the accuracy of the iterative optimization process 214, the results 405 can be tested in a lab environment to produce a set of measured fluid properties 240 for the selected mixture of fluid components 228 from iteration 404. The trained machine-learning model 230 can be further trained using the set of measured fluid properties 240. Thus, the third round 406 can be informed by the results of the second round 404, as well as lab data measured for second round 404.

In some examples, multiple rounds of the iterative optimization process 214 can be run performed that involve two or more separate rounds that are executed in sequence or in parallel. For example, fourth rounds 408a-c can each run concurrently using the optimized compositions determined in the third round 406. In some examples, each of the fourth rounds 408a-c may use a separate trained machine-learning model 230 or subset of the trained machine-learning model. Subsequent rounds (not depicted) can then be informed by the results of multiple previous rounds, such as round 408a and round 408b.

Turing back to FIG. 3, at block 314, the process 300 involves transmitting, by the processing device 202, a control signal 242 to a mixing subsystem 53 for causing the mixing subsystem 53 to produce an optimized composition 222 of the downhole drilling fluid 58. The optimized composition 222 can be the selected mixture of fluid components 228 inputted into the trained machine-learning model 230 in the final iteration of the iterative optimization process 214. The processing device 202 can generate the control signal 242 directing the mixing subsystem 53 to combine the selected mixture of fluid components 228 together in the quantities determined in the iterative optimization process 214, along with any treatments included in the iterative optimization process 214. For example, the mixing subsystem 53 may include chemical tanks that include the various fluid components. The chemical tanks may be connected via pipes to the fluid source 52, where the selected mixture of fluid components 228 can be combined. The control signal 242 can electronically control the valves in the pipes to dispense fluid components from the chemical tanks into the fluid source 52 in the quantities prescribed in the selected mixture of fluid components 228. The selected mixture of fluid components 228 can then be mixed by the mixing subsystem 53 to produce the downhole drilling fluid 58. The produced downhole drilling fluid 58 can have the set of target fluid properties 216 input by the user and can be used downhole in drilling operations.

In some examples, sensor data detected by measurement equipment 73 for the downhole drilling fluid 58 with the optimized composition 222 can be received by the processing device 202. The processing device 202 can determine, based on the sensor data, fluid properties for the downhole drilling fluid 58. If the fluid properties from the sensor data differ from the set of target fluid properties 216, the processing device 202 may use the iterative optimization process to determine an adjustment to the optimized composition 222. For example, the processing device 202 can determine a difference between the fluid properties from the sensor data and the set of target fluid properties 216. The processing device 202 can determine an adjustment to the optimized composition 222 based on the difference. The adjustment to the optimized composition 222 can be a new selected mixture of fluid components 228 that can be inputted into the trained machine-learning model 230 as part of a new iteration of the iterative optimization process 214. After the iterative optimization process 214 produces an updated optimized composition 222 after one or more iterations, the processing device 202 can generate and transmit a new control signal 242 to the mixing subsystem 53. The new control signal 242 can cause the mixing subsystem 53 to produce a new downhole drilling fluid with the updated optimized composition. Alternatively, the new control signal 2424 can cause the mixing subsystem 53 to add additional fluid components or treatments to the existing downhole drilling fluid 58 to produce the updated optimized composition.

In some aspects, system, method, and non-transitory computer-readable medium for producing an optimized composition of a downhole drilling fluid are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: a processing device; and a memory device that includes instructions executable by the processing device for causing the processing device to: receive a set of target fluid properties for a downhole drilling fluid as input from a user; execute an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving: selecting a mixture of fluid components for the downhole drilling fluid from a search space that includes a plurality of different mixtures of fluid components; providing the selected mixture of fluid components as input to a trained machine-learning model, the trained machine-learning model being configured to determine a set of predicted fluid properties for the mixture of fluid components; receiving the set of predicted fluid properties for the mixture of fluid components as output from the trained machine-learning model; and determining whether the set of predicted fluid properties matches the set of target fluid properties; and transmit a control signal to a mixing subsystem for causing the mixing subsystem to produce the optimized composition of the downhole drilling fluid.

Example 2 is the system of example(s) 1, wherein the memory device further includes instructions executable by the processing device for causing the processing device to execute the iterative optimization process by, for a current iteration of the iterative optimization process: determining that the set of predicted fluid properties does not match the set of target fluid properties; determining a difference between the set of predicted fluid properties and the set of target fluid properties; and performing a subsequent iteration of the iterative optimization process based on the difference, such that the subsequent iteration is informed by the difference determined in the current iteration.

Example 3 is the system of example(s) 1-2, wherein the at least one objective function is configured to optimize for drilling speed downhole based on the optimized composition of the downhole drilling fluid.

Example 4 is the system of example(s) 1-3, wherein the memory device further includes instructions executable by the processing device for causing the processing device to: generate the trained machine-learning model by training a machine-learning model using historical data, the historical data indicating fluid properties of candidate fluid components.

Example 5 is the system of example(s) 1-4, wherein the memory device further includes instructions executable by the processing device for causing the processing device to generate the trained machine-learning model by: identifying a subset of fluid components, from among the candidate fluid components listed in the historical data, that perform a same function in the downhole drilling fluid; modifying the historical data to replace the subset of fluid components with a single fluid component that is representative of the subset of fluid components; and training the machine-learning model using the modified historical data to generate the trained machine-learning model.

Example 6 is the system of example(s) 1-5, wherein the memory device further includes instructions executable by the processing device for causing the processing device to: receive a set of measured fluid properties for the mixture of fluid components output from the trained machine-learning model; modify the historical data to include the set of measured fluid properties for the mixture of fluid components; and train the trained machine-learning model using the modified historical data.

Example 7 is the system of example(s) 1-6, wherein the iterative optimization process is implemented using an optimization algorithm, and wherein the optimization algorithm includes a Bayesian optimization algorithm, a genetic algorithm, or a Latin hypercube algorithm.

Example 8 is a method comprising: receiving, by a processing device, a set of target fluid properties for a downhole drilling fluid as input from a user; executing, by the processing device, an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving: selecting, by the processing device, a mixture of fluid components for the downhole drilling fluid from a search space that includes a plurality of different mixtures of fluid components; providing, by the processing device, the selected mixture of fluid components as input to a trained machine-learning model, the trained machine-learning model being configured to determine a set of predicted fluid properties for the mixture of fluid components; receiving, by the processing device, the set of predicted fluid properties for the mixture of fluid components as output from the trained machine-learning model; and determining, by the processing device, whether the set of predicted fluid properties matches the set of target fluid properties; and transmitting, by the processing device, a control signal to a mixing subsystem for causing the mixing subsystem to produce the optimized composition of the downhole drilling fluid.

Example 9 is the method of example(s) 8, wherein executing the iterative optimization process further comprises, for a current iteration of the iterative optimization process: determining that the set of predicted fluid properties does not match the set of target fluid properties; determining a difference between the set of predicted fluid properties and the set of target fluid properties; and performing a subsequent iteration of the iterative optimization process based on the difference, such that the subsequent iteration is formed by the difference determined in the current iteration.

Example 10 is the method of example(s) 8-9, wherein the at least one objective function is configured to optimize for drilling speed downhole based on the optimized composition of the downhole drilling fluid.

Example 11 is the method of example(s) 8-10, further comprising: generating the trained machine-learning model by training a machine-learning model using historical data, the historical data indicating fluid properties of candidate fluid components.

Example 12 is the method of example(s) 8-11, wherein generating the trained machine-learning model further comprises: identifying a subset of fluid components, from among the candidate fluid components listed in the historical data, that perform a same function in the downhole drilling fluid; modifying the historical data to replace the subset of fluid components with a single fluid component that is representative of the subset of candidate fluid components; and training the machine-learning model using the modified historical data to generate the trained machine-learning model.

Example 13 is the method of example(s) 8-12, further comprising: receiving a set of measured fluid properties for the mixture of fluid components output from the trained machine-learning model; modifying the historical data to include the set of measured fluid properties for the mixture of fluid components; and training the trained machine-learning model using the modified historical data.

Example 14 is the method of example(s) 8-13, wherein the iterative optimization process is implemented using an optimization algorithm, and wherein the optimization algorithm includes a Bayesian optimization algorithm, a genetic algorithm, or a Latin hypercube algorithm.

Example 15 is a non-transitory computer-readable medium comprising instructions that are executable by a processing device for causing the processing device to perform operations comprising: receiving a set of target fluid properties for a downhole drilling fluid as input from a user; executing an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving: selecting a mixture of fluid components for the downhole drilling fluid from a search space that includes a plurality of different mixtures of fluid components; providing the selected mixture of fluid components as input to a trained machine-learning model, the trained machine-learning model being configured to determine a set of predicted fluid properties for the mixture of fluid components; receiving the set of predicted fluid properties for the mixture of fluid components as output from the trained machine-learning model; and determining whether the set of predicted fluid properties matches the set of target fluid properties; and transmitting a control signal to a mixing subsystem for causing the mixing subsystem to produce the optimized composition of the downhole drilling fluid.

Example 16 is the non-transitory computer-readable medium of example(s) 15, wherein the instructions are further executable by the processing device for causing the processing device to execute the iterative optimization process by, for a current iteration of the iterative optimization process: determining that the set of predicted fluid properties does not match the set of target fluid properties; determining a difference between the set of predicted fluid properties and the set of target fluid properties; and performing a subsequent iteration of the iterative optimization process based on the difference, such that the subsequent iteration is performed by the difference determined in the current iteration.

Example 17 is the non-transitory computer-readable medium of example(s) 15-16, wherein the at least one objective function is configured to optimize for drilling speed downhole based on the optimized composition of the downhole drilling fluid.

Example 18 is the non-transitory computer-readable medium of example(s) 15-17, wherein the instructions are further executable by the processing device for causing the processing device to: generate the trained machine-learning model by training a machine-learning model using historical data, the historical data indicating fluid properties of candidate fluid components.

Example 19 is the non-transitory computer-readable medium of example(s) 15-18, wherein the instructions are further executable by the processing device for causing the processing device to generate the trained machine-learning model by: identifying a subset of fluid components, from among the candidate fluid components listed in the historical data, that perform a same function in the downhole drilling fluid; modifying the historical data to replace the subset of fluid components with a single fluid component that is representative of the subset of fluid components; and training the machine-learning model using the modified historical data to generate the trained machine-learning model.

Example 20 is the non-transitory computer-readable medium of example(s) 15-19, wherein the instructions are further executable by the processing device for causing the processing device to: receive a set of measured fluid properties for the mixture of fluid components output from the trained machine-learning model; modify the historical data to include the set of measured fluid properties for the mixture of fluid components; and train the trained machine-learning model using the modified historical data.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to:
receive a set of target fluid properties for a downhole drilling fluid as input from a user;
execute an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving:
selecting a mixture of fluid components for the downhole drilling fluid from a search space that includes a plurality of different mixtures of fluid components;
providing the selected mixture of fluid components as input to a trained machine-learning model, the trained machine-learning model being configured to determine a set of predicted fluid properties for the mixture of fluid components;
receiving the set of predicted fluid properties for the mixture of fluid components as output from the trained machine-learning model; and
determining whether the set of predicted fluid properties matches the set of target fluid properties; and
transmit a control signal to a mixing subsystem for causing the mixing subsystem to produce the optimized composition of the downhole drilling fluid.

2. The system of claim 1, wherein the memory device further includes instructions executable by the processing device for causing the processing device to execute the iterative optimization process by, for a current iteration of the iterative optimization process:
determining that the set of predicted fluid properties does not match the set of target fluid properties;
determining a difference between the set of predicted fluid properties and the set of target fluid properties; and
performing a subsequent iteration of the iterative optimization process based on the difference, such that the subsequent iteration is informed by the difference determined in the current iteration.

3. The system of claim 1, wherein the at least one objective function is configured to optimize for drilling speed downhole based on the optimized composition of the downhole drilling fluid.

4. The system of claim 1, wherein the memory device further includes instructions executable by the processing device for causing the processing device to:
generate the trained machine-learning model by training a machine-learning model using historical data, the historical data indicating fluid properties of candidate fluid components.

5. The system of claim 4, wherein the memory device further includes instructions executable by the processing device for causing the processing device to generate the trained machine-learning model by:
identifying a subset of fluid components, from among the candidate fluid components listed in the historical data, that perform a same function in the downhole drilling fluid;
modifying the historical data to replace the subset of fluid components with a single fluid component that is representative of the subset of fluid components; and
training the machine-learning model using the modified historical data to generate the trained machine-learning model.

6. The system of claim 4, wherein the memory device further includes instructions executable by the processing device for causing the processing device to:
receive a set of measured fluid properties for the mixture of fluid components output from the trained machine-learning model;
modify the historical data to include the set of measured fluid properties for the mixture of fluid components; and
train the trained machine-learning model using the modified historical data.

7. The system of claim 1, wherein the iterative optimization process is implemented using an optimization algorithm, and wherein the optimization algorithm includes a Bayesian optimization algorithm, a genetic algorithm, or a Latin hypercube algorithm.

8. A method comprising:
receiving, by a processing device, a set of target fluid properties for a downhole drilling fluid as input from a user;
executing, by the processing device, an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving:
selecting, by the processing device, a mixture of fluid components for the downhole drilling fluid from a search space that includes a plurality of different mixtures of fluid components;
providing, by the processing device, the selected mixture of fluid components as input to a trained machine-learning model, the trained machine-learning model being configured to determine a set of predicted fluid properties for the mixture of fluid components;
receiving, by the processing device, the set of predicted fluid properties for the mixture of fluid components as output from the trained machine-learning model; and
determining, by the processing device, whether the set of predicted fluid properties matches the set of target fluid properties; and
transmitting, by the processing device, a control signal to a mixing subsystem for causing the mixing subsystem to produce the optimized composition of the downhole drilling fluid.

9. The method of claim 8, wherein executing the iterative optimization process further comprises, for a current iteration of the iterative optimization process:
determining that the set of predicted fluid properties does not match the set of target fluid properties;
determining a difference between the set of predicted fluid properties and the set of target fluid properties; and
performing a subsequent iteration of the iterative optimization process based on the difference, such that the subsequent iteration is formed by the difference determined in the current iteration.

10. The method of claim 8, wherein the at least one objective function is configured to optimize for drilling speed downhole based on the optimized composition of the downhole drilling fluid.

11. The method of claim 8, further comprising:
generating the trained machine-learning model by training a machine-learning model using historical data, the historical data indicating fluid properties of candidate fluid components.

12. The method of claim 11, wherein generating the trained machine-learning model further comprises:
identifying a subset of fluid components, from among the candidate fluid components listed in the historical data, that perform a same function in the downhole drilling fluid;
modifying the historical data to replace the subset of fluid components with a single fluid component that is representative of the subset of candidate fluid components; and
training the machine-learning model using the modified historical data to generate the trained machine-learning model.

13. The method of claim 11, further comprising:
receiving a set of measured fluid properties for the mixture of fluid components output from the trained machine-learning model;
modifying the historical data to include the set of measured fluid properties for the mixture of fluid components; and
training the trained machine-learning model using the modified historical data.

14. The method of claim 8, wherein the iterative optimization process is implemented using an optimization algorithm, and wherein the optimization algorithm includes a Bayesian optimization algorithm, a genetic algorithm, or a Latin hypercube algorithm.

15. A non-transitory computer-readable medium comprising instructions that are executable by a processing device for causing the processing device to perform operations comprising:
receiving a set of target fluid properties for a downhole drilling fluid as input from a user;
executing an iterative optimization process configured to determine an optimized composition of the downhole drilling fluid that satisfies at least one objective function and matches the set of target fluid properties, wherein the iterative optimization process is configured to iterate until a stopping condition is satisfied, each iteration of the iterative optimization process involving:
selecting a mixture of fluid components for the downhole drilling fluid from a search space that includes a plurality of different mixtures of fluid components;
providing the selected mixture of fluid components as input to a trained machine-learning model, the trained machine-learning model being configured to determine a set of predicted fluid properties for the mixture of fluid components;
receiving the set of predicted fluid properties for the mixture of fluid components as output from the trained machine-learning model; and
determining whether the set of predicted fluid properties matches the set of target fluid properties; and
transmitting a control signal to a mixing subsystem for causing the mixing subsystem to produce the optimized composition of the downhole drilling fluid.

16. The non-transitory computer-readable medium of claim 15, wherein the instructions are further executable by the processing device for causing the processing device to execute the iterative optimization process by, for a current iteration of the iterative optimization process:
determining that the set of predicted fluid properties does not match the set of target fluid properties;
determining a difference between the set of predicted fluid properties and the set of target fluid properties; and
performing a subsequent iteration of the iterative optimization process based on the difference, such that the subsequent iteration is performed by the difference determined in the current iteration.

17. The non-transitory computer-readable medium of claim 15, wherein the at least one objective function is configured to optimize for drilling speed downhole based on the optimized composition of the downhole drilling fluid.

18. The non-transitory computer-readable medium of claim 15, wherein the instructions are further executable by the processing device for causing the processing device to:
generate the trained machine-learning model by training a machine-learning model using historical data, the historical data indicating fluid properties of candidate fluid components.

19. The non-transitory computer-readable medium of claim 18, wherein the instructions are further executable by the processing device for causing the processing device to generate the trained machine-learning model by:
identifying a subset of fluid components, from among the candidate fluid components listed in the historical data, that perform a same function in the downhole drilling fluid;
modifying the historical data to replace the subset of fluid components with a single fluid component that is representative of the subset of fluid components; and
training the machine-learning model using the modified historical data to generate the trained machine-learning model.

20. The non-transitory computer-readable medium of claim 18, wherein the instructions are further executable by the processing device for causing the processing device to:
receive a set of measured fluid properties for the mixture of fluid components output from the trained machine-learning model;
modify the historical data to include the set of measured fluid properties for the mixture of fluid components; and
train the trained machine-learning model using the modified historical data.
